(19) United States
(12) Patent Application Publication
(10) Pub. No.: US 2019/0288510 A1
(43) Pub. Date: Sep. 19, 2019

(54) APPARATUS AND METHOD FOR MANAGING PEAK POWER OF ZERO-ENERGY TOWN

(71) Applicant: ELECTRONICS AND TELECOMMUNICATIONS RESEARCH INSTITUTE, Daejeon (KR)

(72) Inventor: Hong Soon NAM, Daejeon (KR)

(21) Appl. No.: 16/192,931

(22) Filed: Nov. 16, 2018

(30) Foreign Application Priority Data
Mar. 13, 2018 (KR) 10-2018-0029192

(51) Int. Cl. H02J 3/28; H02J 13/00; G05B 13/02

(52) U.S. Cl. CPC H02J 3/28; G05B 13/024; H02J 13/0006

(57) ABSTRACT

A method of managing a peak power of a zero-energy town (ZET) includes monitoring a grid power transmitted between the ZET and a grid, and controlling an energy storage systems (ESSs) provided in the ZET based on a result of the monitoring, wherein the controlling includes supplying a power stored in the ESSs to an energy load or storing a power produced by the ZET in the ESSs so as to lower a peak power of the grid power.

### CROSS-REFERENCE TO RELATED APPLICATION

This application claims the priority benefit of Korean Patent Application No. 10-2018-0029192, filed Mar. 13, 2018, in the Korean Intellectual Property Office, the disclosure of which is incorporated herein by reference for all purposes.

### BACKGROUND

### 1. Field of the Invention

One or more example embodiments relate to an apparatus and method for managing a peak power of a zero-energy town (ZET).

### 2. Description of Related Art

A zero-energy building (ZEB) is a building of which an annual average energy consumption is zero through distributed energy resources such as eco-friendly energy sources. However, the ZEB requires a high construction cost, and thus it may be difficult to implement zero energy consumption depending on a building environment. To overcome such a disadvantage of the ZEB, a zero-energy town (ZET), which is an extension of the concept of zero energy consumption to a unit of town, has been introduced.

The ZET adjusts an energy consumption through internally distributed energy resources and a grid such that the annual average energy consumption of the town, in which various types of buildings such as ZEBs, non-zero energy buildings (non-ZEBs), residential buildings, and non-residential buildings coexist, is, zero.

A smart grid is a system which manages supply of a power by providing suppliers and producers with information on consumers, the system which combines information and communications technology with a power system, thereby providing a high-quality power service.

### SUMMARY

The ZET may include a plurality of buildings, a plurality of loads, a plurality of Distributed Energy Resources (DERs) and a plurality of Energy Storage Sources (ESSs).

According to an aspect, there is provided a method of managing a peak power of a zero-energy town (ZET), the method including monitoring a grid power transmitted between the ZET and a grid, and controlling an energy storage systems (ESSs) provided in the ZET based on a result of the monitoring, wherein the controlling may include supplying a power stored in the ESSs to an energy load or storing a power produced by the ZET in the ESSs so as to lower a peak power of the grid power.

The controlling may include controlling the ESSs to increase the power of the ESSs in response to an increase in the grid power, and to decrease the power of the ESSs in response to a decrease in the grid power.

The controlling may include determining a gain of an ESS control power to control the ESS based on a change in the grid power, calculating the ESS control power based on the determined gain, and controlling the ESS based on the calculated ESS control power.

The gain of the ESS control power may be determined based on information related to the charge state of the ESSs and information related to the charge capacity of the ESSs.

The determining may include determining the gain of the ESS control power to be a first gain to increase the ESS control power in response to the grid power being increased or unchanged, and determining the gain of the ESS control power to be a second gain to decrease the ESS control power in response to the grid power being decreased.

The calculating may include calculating an ESS control power at a current point in time based on an ESS control power at a previous point in time in a recursive manner.

The calculating may include calculating the ESS control power based on a variation in the grid power or based on a current power value of the grid power.

The calculating may include calculating the ESS control power based on an average power of the grid power for a preset period if the average power of the grid power is not zero.

The monitoring may include monitoring the grid power based on a metering device provided in the ZET.

According to another aspect, there is provided an apparatus for managing a peak power of a ZET, the apparatus including a monitor configured to monitor a grid power transmitted between the ZET and a grid, a peak power controller configured to calculate an ESS, control power to control an ESS provided in the ZET based on a result of the monitoring, and an ESS controller configured to control a power of the ESS based on the calculated ESS control power.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating an overall configuration of a zero-energy town (ZET) according to an example embodiment;

FIG. 2 is a block diagram illustrating an overall configuration of a peak power management system according to an example embodiment;

FIG. 3 is a flowchart illustrating a method of controlling a peak power of a ZET using a peak power controlling apparatus according to an example embodiment;

FIG. 4A illustrates graphs showing powers of constituent elements of a ZET over time according to Equation 6 according to an example embodiment;

FIG. 4B illustrates graphs showing powers of constituent elements of a ZET over time according to Equation 7 according to an example embodiment; and

FIG. 5 is a block diagram illustrating an overall configuration of a peak power management apparatus according to an example embodiment.

### DETAILED DESCRIPTION

Hereinafter, some example embodiments will be described in detail with reference to the accompanying drawings. However, various alterations and modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted, as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. When it is determined detailed description related to a related known function or configuration they may make the purpose of the examples unnecessarily ambiguous in describing the examples, the detailed description will be omitted here.

A zero-energy town (ZET) is aimed at making an annual average energy consumption zero with respect to a power transmitted through a grid, a power produced through distributed energy resources (DERs), and an energy consumption of a plurality of zero-energy buildings (ZEBs), non-ZEBs, and residential or non-residential buildings. The ZET produces a required power through the DERs such as, for example, solar power generation and wind power generation apparatuses, in the town, and makes the annual average energy consumption of the town zero by applying methods that increase an efficiency of energy used. In an example in which energy to be used in the town lacks, the ZET may receive energy from, an external grid. In an example in which surplus energy occurs, the ZET may supply the energy to the external grid. The DERs such as a solar power generation apparatus of the ZET have a relatively great variability in power generation depending on the weather and thus, may increase a peak power. Further, an amount of energy to be used by an energy load such as a building in the ZET cannot be predicted exactly. Thus, a grid needs to secure more backup power to prepare for the peak power and needs to include large transmitting/distributing facilities for the peak power. The securing of backup power and large facilities may increase a unit cost of electricity, which falls to consumers. To explain briefly, multiple ESSs, DERs, loads can be represented as an ESS, a DER and a load, respectively.

To manage the peak power of the grid power, the ZET may additionally include an energy storage system (ESS) and an emergency generator. If a power production through the DER in the ZET is less than a power demand, insufficient power may be received from the grid or the ESS. If the power production is greater than the power demand, a power exceeding the power demand may be stored in the ESS or supplied to the grid.

To manage the peak power, the ZET may be scheduled to charge the ESS for a light-load period of time during which a power demand is relatively low and to discharge the energy stored in the ESS for a period of time during which a power consumption is relatively great. However, such a manner may hardly reflect the power demand in real time.

A peak power management system continuously monitors the grid power to more effectively manage the peak power of the grid power. Based on a result of the monitoring, the peak power management system may increase the power of the ESS in response to an increase in the grid power (in response to an increase in energy demand) and decrease the power of the ESS in response to a decrease in the grid power, thereby reducing the variability of the grid power and thus, adjusting the peak power of the grid power to a predetermined level.

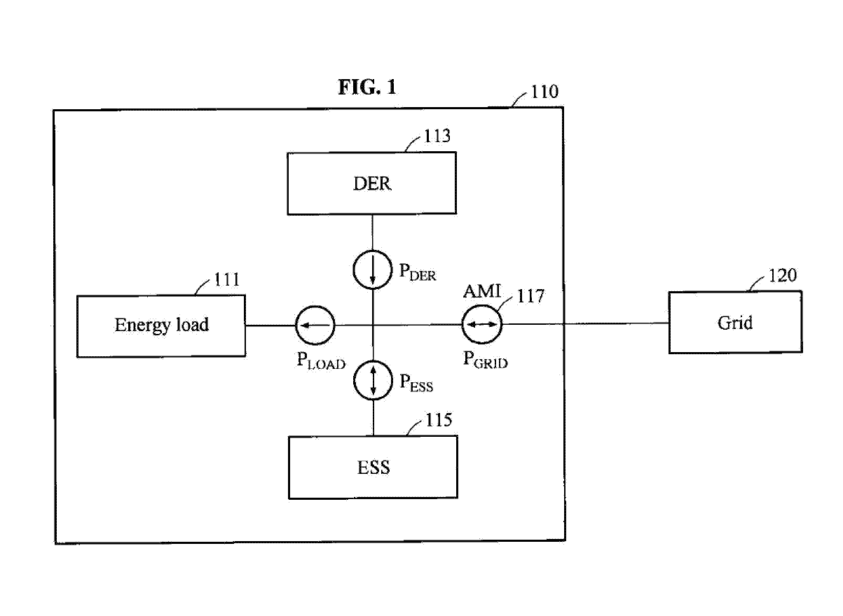

FIG. 1 is a block diagram illustrating an overall configuration of a ZET according to an example embodiment.

Referring to FIG. 1, a ZET 110 may include an energy load 111 that consumes a power, the energy load 111 including a plurality of ZEBs, non-ZEBs, residential buildings, and non-residential buildings. The ZET 110 may produce energy to be used by the energy load 111 through a DER 113 such that an annual average energy consumption of the entire town may be zero. The DER 113 may be eco-friendly power generation facilities including solar power generation facilities and wind power generation facilities. The ZET 110 may receive a power through an ESS 115 or a grid 120 if the power used by the energy load 111 is greater than a power produced by the DER 113 and provide a surplus power to the ESS 115 or the grid 120 if the power used by the energy load 111 is less than the power produced by the DER 113, thereby achieving zero energy consumption. If zero energy consumption can be achieved without considering peak management, a large amount of backup power and power transmitting/distributing facilities to prepare for a peak power may be needed, and the large amount, of backup power and the power transmitting/distributing facilities may increase a monthly basic electricity cost of electricity (electricity bill). That is because a monthly basic electricity cost may be determined depend on the recent yearly peak power.

A peak power management system may monitor a grid power in real time through an advanced metering infrastructure (AMI) and control a power of the ESS 115 based on a result of the monitoring, thereby maintaining the peak power within a predetermined range.

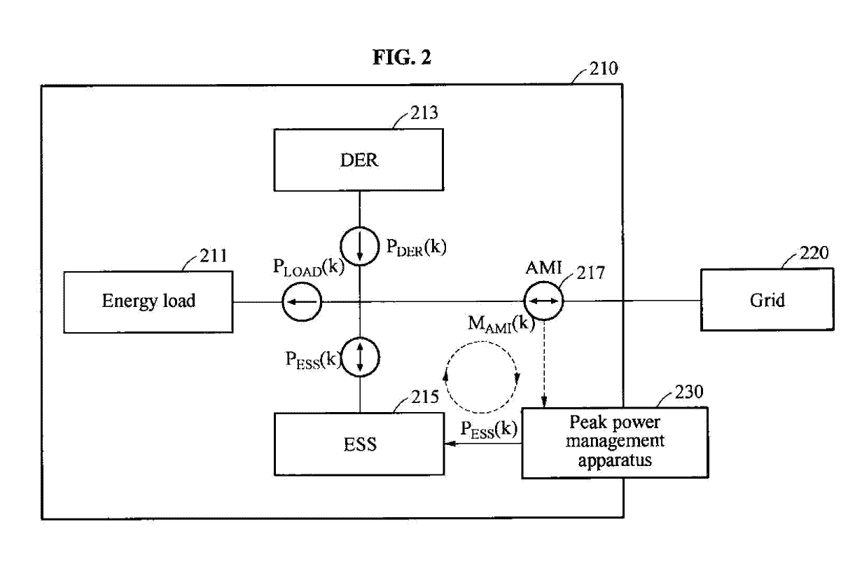

FIG. 2 is a block diagram illustrating an overall configuration of a peak power management system according to an example embodiment.

Referring to FIG. 2, a peak power management system may control an operation of an existing ZET 210 through a peak power management apparatus 230.

The peak power management system may receive a power through an ESS 215 or a grid 220 if a power used by an energy load 211 is greater than a power produced by a DER 213 and supply a power through the ESS 215 or the grid 220 if the power used by the energy load 211 is less than the power produced by the DER 213.

A load power P_{LOAD} of the energy load 211 in the ZET 210 may be expressed by Equation 1.

P_{LOAD}=P_{DER}+P_{ESS}+P_{GRID} [Equation 1]

In Equation 1, P_{DER} denotes a power of the DER, and P_{ESS} denotes a power of the ESS. The power may be expressed as a positive number if the power flows in a direction to be supplied to the energy load 211 and may be expressed as a negative number if the power flows in an opposite direction.

Referring to Equation 1, P_{GRID} may be controlled based on P_{ESS}. Thus, the peak power management apparatus 230 may manage a peak power of P_{GRID} by controlling P_{ESS} based on a result of monitoring P_{GRID}.

The peak power management system may monitor the grid power based on a metering device 217 provided in the ZET 210. For example, the metering device 217 provided in the ZET 210 may be an AMI. P_{GRID} may be monitored by the metering device 217, and P_{ESS}> may be controlled based on a result of the monitoring.

The metering device 217 may measure a grid power that the ZET 210 supplies to or receives from the grid 220 through a power consumption observed for a predetermined period of time. In Equation 2, M_{AMI}(k) denotes a power consumption of the ZET measured at a point in time, and M_{AMI}(k−1) denotes a power consumption of the ZET measured at a previous point in time.

The grid power P_{GRID} which corresponds to an average power consumption of the ZET for a measuring period may be expressed through the power consumptions of the ZET measured through the metering device 217, as given by Equation 2.

P_{GRID}=[M_{AMI}(k)+M_{AMI}(k−1)]/Δt [Equation 2]

The ESS 215 may be controlled based on a predetermined threshold T such that the ESS 215 may be more effectively used in the ZET 210. Further, if an annual average energy consumption of the ZET 210 is not zero, an annual average grid power P_{GRID} may be determined to be the threshold T, whereby the ESS 215 may be controlled according to Equation 3.

P_{GRID}=[M_{AMI}(k)+M_{AMI}(k−1)]/Δt−T [Equation 3]

In Equation 3, T denotes a threshold predetermined with respect to P_{GRID}.

The peak power management apparatus 230 may monitor the grid power through the AMI 217 provided in the ZET, calculate an ESS control power to control the power of the ESS based on a result of the monitoring, control the power of the ESS 215 based on the calculated ESS control power, and, manage the peak power of P_{GRID} through the power of the ESS 215.

The peak power management apparatus 230 may supply the energy stored in the ESS 215 to the energy load 211 or store a power produced by the ZET 210 in the ESS 215 so as to lower the peak power of P_{GRID}.

The peak power management apparatus 230 may control the ESS to increase the power of the ESS in response to an increase in the grid power and to decrease the power of the ESS in response to a decrease in the grid, power. The peak power management apparatus 230 may increase P_{ESS} in response to an increase in P_{GRID} to prevent a further increase in P_{GRID} and decrease P_{ESS} in response to a decrease in P_{GRID}, thereby maintaining P_{GRID} at a predetermined level and managing the peak power of P_{GRID}.

The peak power management apparatus 230 may calculate an ESS control power at a current point in time based on an ESS control power at a previous point in time in a recursive manner. Further, the peak power management apparatus 230 may calculate the ESS control power based on a variation in the grid power. For example, the peak power management apparatus 230 may calculate P_{ESS} based on a variation in the ESS control power in a recursive manner according to Equation 4.

P_{ESS}(k)=P_{ESS}(k−1)+G(k)[P_{GRID}(k)−P_{ESS}(k−1)−P_{GRID}(k−1)+P_{ESS}(k−2)] [Equation 4]

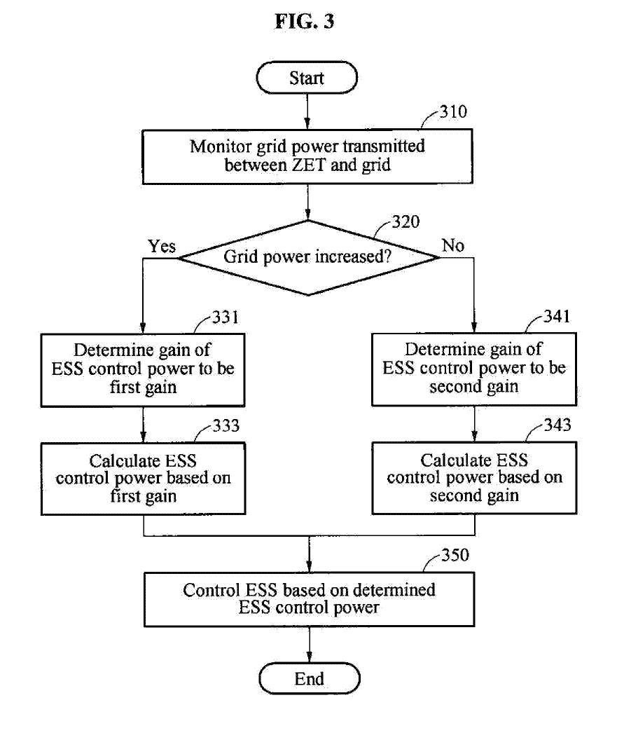

Equation 4 may be similar to the Kalman filter, and a gain G(k) may be determined based on P_{ESS}(t), a capacity of the ESS 215, and a charge state of the ESS 215. A method determining G(k) will be described further with reference to FIG. 3. The Kalman filter is a filter which operates in a recursive manner that estimates an actual value from measured data and calculates a Kalman gain based on an error covariance of the estimated value.

The peak power management apparatus 230 may calculate the ESS control power based on a current power value of the grid power. For example, the peak power management apparatus 230 may calculate P_{ESS} based on the current power value of P_{GRID} through Equation 5.

P_{ESS}(k)=P_{ESS}(k−1)+G(k)P_{GRID}(k) [Equation 5]

In an example in which P_{ESS} is calculated according to Equation 4, a graphic representation of each of P_{ESS} and P_{LOAD} may be similar to a graphic representation of a sum of P_{DER} and P_{LOAD}. Further, in an example in which P_{ESS} is calculated according to Equation 5, a graphic representation of P_{ESS} may be similar to the graphic representation of the sum of P_{DER} and P_{LOAD}.

FIG. 3 is a flowchart illustrating a method of controlling a peak power of a ZET using a peak power controlling apparatus according to an example embodiment.

In operation 310, a peak power controlling apparatus may monitor a grid power transmitted between a ZET and a grid. The peak power controlling apparatus may monitor the grid power in real time through an AMI provided in the ZET.

In operation 320, the peak power controlling apparatus may verify whether the grid power is increased. The peak power controlling apparatus may determine a gain of an ESS control power based on a change in the grid power and calculate the ESS control power based on the determined gain. For example, the peak power controlling apparatus may compare an amount of grid power at a previous point in time to an amount of grid power at a current point in time, thereby verifying whether the grid power is increased, decreased, or unchanged.

In response to the grid power being increased or unchanged, the peak power controlling apparatus, may determine the gain of the ESS control power to be a first gain to increase the ESS control power, in operation 331, and calculate the ESS control power based on the determined first gain, in operation 333.

In response to the grid power being decreased, the peak power controlling apparatus may determine the gain of the ESS control power to be a second gain to decrease the ESS control power, in operation 341, and calculate the ESS control power based on the determined second gain, in operation 343.

The peak power controlling, apparatus may conserve P_{GRID} by increasing P_{ESS} in response to an increase in P_{GRID} and decrease P_{ESS} in response to a decrease in P_{GRID}, thereby adjusting the peak power of P_{GRID}.

The peak power controlling apparatus may determine the gain of the ESS control power based on information related to a charge state of the ESS and information related to a charge capacity of the ESS. For example, the peak power controlling apparatus may calculate the first gain to increase the ESS control power and the second gain to decrease the ESS control power according to Equations 6 and 7, respectively.

G1(k)=α[q(k)/Q] [Equation 6]

G2(k)=β[1−q(k)/Q] [Equation 7]

In Equations 6 and 7, G1(k) denotes the first gain, G2(k) denotes the second gain, α and β denote proportional constants, q(k) denotes a charge state of the ESS, and Q denotes a maximum charge capacity of the ESS.

For example, the first gain and the second gain may determine a charging or discharging speed of the ESS.

The peak power controlling apparatus may calculate the ESS control power based on the determined gain of the ESS control power and Equation 4 or 5.

In operation 350, the peak power controlling, apparatus may control the ESS based on the determined or calculated ESS control power.

The peak power controlling apparatus may calculate the ESS control power in the recursive manner, and thus a currently calculated value of P_{ESS}(k) may be used as P_{ESS}(k−1) in Equation 4 or 5 to calculate an ESS control power at a later point in time.

In an example in which a number of ESSs exist in the ZET, power may need to be distributed thereto in proper amounts in view of a current state, storage capacities of the ESSs, and discharging speeds of the ESSs.

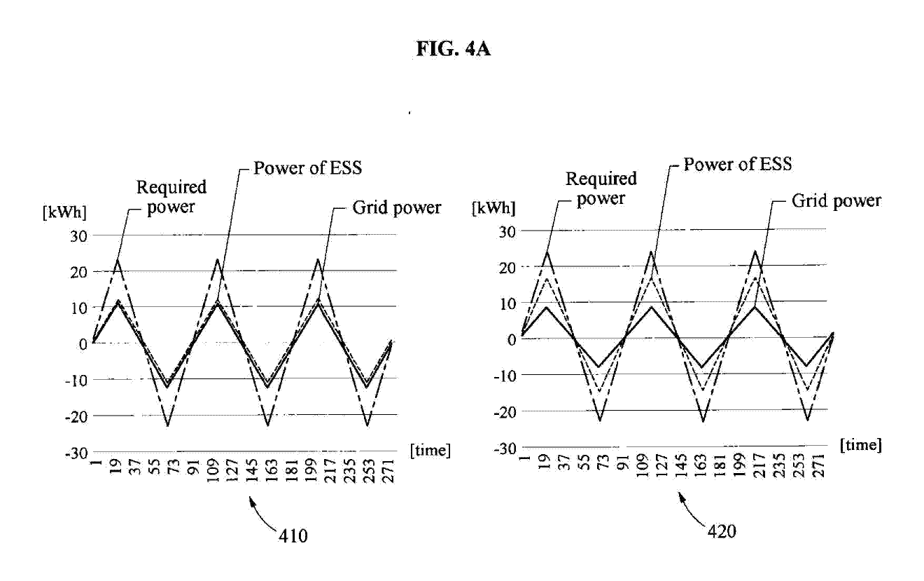

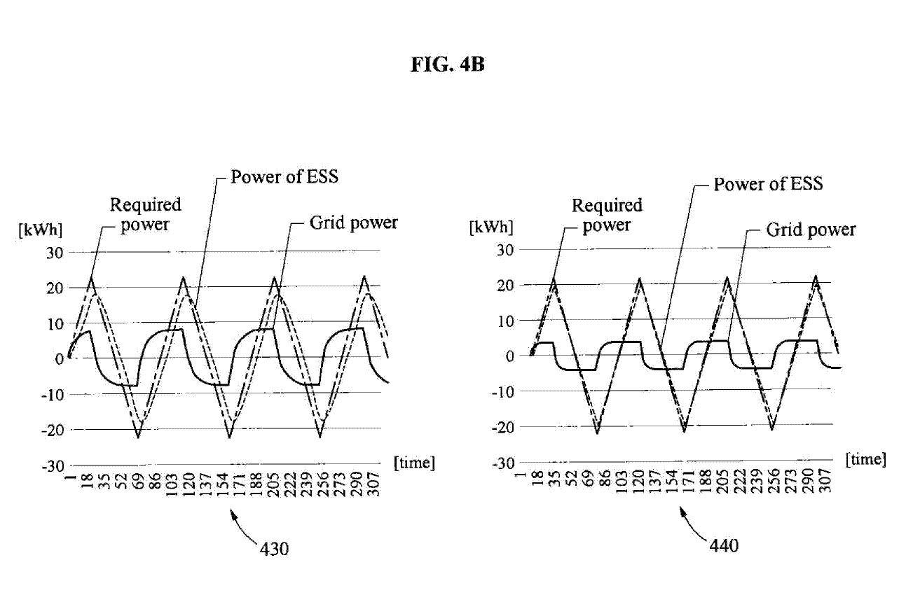

FIG. 4A illustrates graphs showing powers of constituent elements of a ZET over time according to Equation 6 according to an example embodiment.

A graph 410 illustrates respective powers in a case of G1=0.5, and a graph 420 illustrates respective powers in a case of G1=⅔.

In FIG. 4A, a required power denotes a sum of P_{LOAD} and P_{DER}. The required power is equal to a sum of P_{GRID} and P_{ESS} based on Equation 1.

Referring to FIG. 4A, graphic representations of a power of an ESS and a grid power may be similar to a representation of the required power, that is, a power of an energy load. It may be verified that P_{GRID} converges to the required power more quickly as the first gain G1 increases, and P_{GRID} converges to the required power more slowly as the first gain G1 decreases. If P_{GRID} converges to the required power more quickly, the ESS may be charged and discharged relatively quickly, and thus an ESS with a relatively great capacity may be needed. If P_{GRID} converges to the required power more slowly, the ESS may be charged and discharged relatively slowly, and thus the ESS may not sufficiently conserve P_{GRID}, and P_{GRID} may change severely. That is, the peak power may not be managed appropriately.

FIG. 4B illustrates graphs showing powers of constituent elements of a ZET over time according to Equation 7 according to an example embodiment.

A graph 430 illustrates respective powers in a case of G2=0.25, and a graph 440 illustrates respective powers in a case of G2=0.125.

Referring to FIG. 4B, in response to a decrease in P_{GRID}, P_{GRID} may be restricted at a predetermined level through a second gain as shown in the graphs. Referring to FIG. 4B, it may be verified that a power of an ESS increases if G2 decreases.

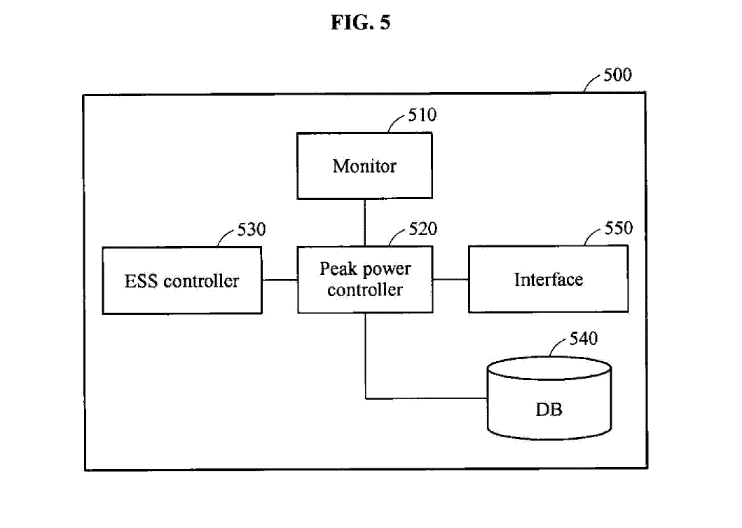

FIG. 5 is a block diagram illustrating an overall configuration of a peak power management apparatus according to an example embodiment.

Referring to FIG. 5, a peak power management apparatus 500 may include a monitor 510 configured to monitor a grid power transmitted between a ZET and a grid, a peak power controller 520 configured to calculate an ESS control power to control an ESS included in the ZET based on a result of the monitoring, an ESS controller 530 configured to control a power of the ESS based on the calculated ESS control power, a database (DB) 540, and an interface 550 configured to receive a user input.

The peak power controller 520 may calculate the ESS control, power for supplying the power stored in the ESS to an energy load or storing a power produced by the ZET in the ESS so as to lower a peak power of the grid power.

The peak power controller 520 may calculate the ESS control power to increase the power of the ESS in response to an increase in the grid power, and to decrease the power of the ESS in response to a decrease in the grid power.

The peak power controller 520 may determine a gain of the ESS control power to control the ESS based on a change in the grid power, calculate the ESS control power based on the determined gain, and transmit the calculated ESS control power to the ESS controller 530.

The gain of the ESS control power may be determined based on information related to a charge state of the ESS and information related to a charge capacity of the ESS. The gain of the ESS control power may be determined to be a first gain to increase the ESS control power in response to the grid power being increased or unchanged. The gain of the ESS control power may be determined to be a second gain to decrease the ESS control power in response to the grid power being decreased. The gain of the ESS control power may be calculated according to Equations 6 and 7.

The peak power controller 520 may calculate an ESS control power at a current, point in time based on an ESS controller at a previous point in time in a recursive manner. Further, the peak power controller 520 may calculate the ESS control power based on a variation in the grid power or a current power value of the grid power. The ESS control power may be calculated according to Equations 4 and 5.

The monitor 510 may monitor the grid power based on a metering device provided in the ZET. For example, the metering device may be an AMI.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example, embodiments, or vice versa.

The software may include a computer program, a piece of code, an instruction, or some combination thereof, to independently or collectively instruct and/or configure the processing device to operate as, desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of managing a peak power of a zero-energy town (ZET), the method comprising:
monitoring a grid power transmitted between the ZET and a grid; and
controlling energy storage systems (ESSs) provided in the ZET based on a result of the monitoring,
wherein the controlling comprises supplying a power stored in the ESSs to an energy load or storing a power produced by the ZET in the ESSs so as to lower a peak power of the grid power.

2. The method of claim 1, wherein the controlling comprises controlling the ESSs to increase the power of the ESSs in response to an increase in the grid power, and to decrease the power of the ESSs in response to a decrease in the grid power.

3. The method of claim 1, wherein the controlling comprises:
determining a gain of an ESS control power to control the ESS based on a change in the grid power;
calculating the ESS control power based on the determined gain; and
controlling the ESS based on the calculated ESS control power.

4. The method of claim 3, wherein the gain of the ESS control power is determined based on information related to the charge state of the ESSs and information related to the charge capacity of the ESSs.

5. The method of claim 3, wherein the determining comprises:
determining the gain of the ESS control power to be a first gain to increase the ESS control power in response to the grid power being increased or unchanged; and
determining the gain of the ESS control power to be a second gain to decrease the ESS control power in response to the grid power being decreased.

6. The method of claim 3, wherein the calculating comprises calculating an ESS control power at a current point in time based on an ESS control power at a previous point in time in a recursive manner.

7. The method of claim 6, wherein the calculating comprises calculating the ESS control power based on a variation in the grid power.

8. The method of claim 6, wherein the calculating comprises calculating the ESS control power based on a current power value of the grid power.

9. The method of claim 3, wherein the calculating comprises calculating the ESS control power based on an average power of the grid power for a preset period if the average power of the grid power is not zero.

10. The method of claim 1, wherein the monitoring comprises monitoring the grid power based on a metering device provided in the ZET.

11. An apparatus for managing a peak power of a zero-energy town (ZET), the apparatus comprising:
a monitor configured to monitor a grid power transmitted between the ZET and a grid;
a peak power controller configured to calculate an energy storage system (ESS) control power to control an ESS provided in the ZET based on a result of the monitoring; and
an ESS controller configured to control a power of the ESS based on the calculated ESS control power.

12. The apparatus of claim 11, wherein the peak power controller is configured to calculate the ESS control power for supplying the power stored in the ESS to an energy load or storing a power produced by the ZET in the ESS so as to lower a peak power of the grid power.

13. The apparatus of claim 11, wherein the peak power controller is configured to calculate the ESS control power to increase the power of the ESS in response to an increase in the grid power, and to decrease the power of the ESS in response to a decrease in the grid power.

14. The apparatus of claim 11, wherein the peak power controller is configured to determine a gain of the ESS control power to control the ESS based on a change in the grid power, calculate the ESS control power based on the determined gain, and transmit the calculated ESS control power to the ESS controller.

15. The apparatus of claim 14, wherein the gain of the ESS control power is determined based on information related to a charge state of the ESSs and information related to a charge capacity of the ESSs.

16. The apparatus of claim 14, wherein the peak power controller is configured to:
determine the gain of the ESS control power to be a first gain to increase the ESS control power in response to the grid power being increased or unchanged; and
determine the gain of the ESS control power to be a second gain to decrease the ESS control power in response to the grid power being decreased.

17. The apparatus of claim 14, wherein the peak power controller is configured to calculate an ESS control power at a current point in time based on an ESS control power at a previous point in time in a recursive manner.

18. The apparatus of claim 17, wherein the peak power controller is configured to calculate the ESS control power based on a variation in the grid power.

19. The apparatus of claim 17, wherein the peak power controller is configured to calculate the ESS control power based on a current power value of the grid power.

20. The apparatus of claim 11, wherein the monitor is configured to monitor the grid power based on a metering device provided in the ZET.
